(19) United States
(12) Patent Application Publication
(10) Pub. No.: US 2020/0321163 A1
(43) Pub. Date: Oct. 8, 2020

(54) Lateral Photovoltaic Window for a Public Transportation Vehicle, Associated Photovoltaic Power Generation System and Public Transportation Vehicle

(71) Applicant: Bombardier Transportation GmbH, berlin (DE)

(72) Inventor: Emanuele Castellazi, Calice Ligure (IT)

(21) Appl. No.: 16/304,191

(22) PCT Filed: May 22, 2017
(86) PCT No.: PCT/EP2017/062310

§ 371 Date: Nov. 23, 2018

(30) Foreign Application Priority Data
May 24, 2016 (EP) 16171184.1

(51) Int. Cl. H01G 9/20; B60J 1/08; B60L 8/00; H02S 30/10

(52) U.S. Cl. CPC H01G 9/2077; B60J 1/08; H02S 40/32; H02S 30/10; B60L 8/003

(57) ABSTRACT

A lateral window for a public transportation vehicle has a first transparent panel, a second transparent panel spaced apart from the first transparent panel, and a window frame for supporting the first transparent panel and the second transparent panel. An inner space filled a transparent photovoltaic gel is defined between the first and second transparent panels and the window frame. A filling arrangement is provided for filling the inner space between the first transparent panel and second transparent panel with the photovoltaic gel.

### TECHNICAL FIELD OF THE INVENTION

The present invention relates a lateral window of a passenger rail vehicle, and more generally a lateral window of a public transportation vehicle.

### BACKGROUND ART

CN203573992U discloses a laminated photovoltaic module, comprising in a top-down sequence an upper ultra-clear float glass, an upper transparent polyvinyl butiral (PVB) layer, a sheet of photovoltaic cells, a lower transparent polyvinyl butiral layer and an underlying ordinary PVB transparent glass. The individual photovoltaic cells are connected to one another and to an external circuit by wires. The module can be used in building e.g. as double glass windows, French windows, glass walls, ceiling, sightseeing elevator, balcony, etc. Such modules are custom modules, which have to be specifically designed for each application. In particular, the size and distribution of the individual photovoltaic cells has to be adapted to the size and shape of the available window frame. The photovoltaic cells and wires hinder the view when the observer looking through the photovoltaic module is close to it. Hence, it is not adapted to vehicle windows, in particular to lateral windows of public transportation vehicles. Moreover, The use of amorphous or crystalline silica for conventional photovoltaic cells is problematic because of the low availability of the raw material and of the high cost and energy needed for its manufacture.

DE102009029790 discloses a lateral window for a transportation vehicle, comprising: a first transparent panel, a second transparent panel spaced apart from the first transparent panel, a window frame for supporting the first transparent panel and the second transparent panel, an inner space being defined between the first and second transparent panels and the window frame, and a photovoltaic generator arranged between the first and second transparent panels. The photovoltaic generator comprises a multi-layered colorant-photovoltaic layer arranged that constitutes an anode and a one-side electrically conductive polymer foil that constitutes a cathode. A generator layer is arranged between the anode and the cathode, and has an ionic material of titanium oxide or zinc oxide with artificial colour pigments as ionic partner for a given wavelength range of solar radiation.

### SUMMARY OF THE INVENTION

The invention aims to provide a low cost photovoltaic module for equipping the lateral windows of a public transportation vehicle.

According to a first aspect of the invention, there is provided a lateral window for a public transportation vehicle, comprising:
a first transparent panel,
a second transparent panel spaced apart from the first transparent panel,
a window frame comprising a main profile for supporting the first transparent panel and the second transparent panel, an inner space being defined between the first and second transparent panels and the window frame,
a transparent photovoltaic gel filling the inner space, and
a filling arrangement for filling the inner space between the first transparent panel and second transparent panel with the photovoltaic gel.

The resulting arrangement offers a uniform transparent surface.

According to an embodiment, the photovoltaic gel contains a silicon gel and a semiconductor.

Preferably, the photovoltaic gel completely fills the inner space.

According to an embodiment, the first and second transparent panels are planar. Curved transparent panels are also possible.

The filling arrangement may comprise a filling inlet for introducing the photovoltaic gel into the inner space, a pressure compensation outlet for allowing air to leave the inner space and closure elements for closing the filling inlet and pressure compensation outlet. According to one embodiment, the filling inlet comprises a through hole in the first transparent panel. Similarly, the pressure compensation outlet comprises a through hole in the first transparent panel. This arrangement is particularly simple and makes it possible to fill the inner space after the lateral window has been mounted on the vehicle. Alternatively, the filling inlet and pressure compensation outlet are arranged in one or more frame members of the window frame, with the advantage that the filing inlet and pressure compensation outlet are not visible

According to an embodiment, the lateral window is provided with a pair of electrodes spaced apart from one another for electrically connecting the photovoltaic gel to an outside electrical circuit through the window frame. One of the advantages of the invention is that only one pair of electrodes is necessary, i.e. the whole window operates as a single photovoltaic cell. Preferably, the electrodes are arranged on the window frame. The electrodes are not visible and do not hinder the view.

According to a preferred embodiment at least two openings are provided in the window frame. The two openings form the filling inlet and pressure outlet and are closed by bushings that connect the electrodes to the outside circuit. Alternatively, different openings in the window frame can be used for the electric bushings and the inlet and outlet openings.

According to another aspect of the invention, there is provided a photovoltaic power generation system for a public transportation vehicle, characterized in that it includes a set of one or more lateral windows as described above and an electrical circuit for connecting the electrodes of the one or more lateral windows to one or more electrical components amongst the following:
a set of one or more batteries;
one or more DC loads; and/or
one or more AC loads.

According to an embodiment, the electrical circuit includes a charger controller between the electrodes and the one or more electrical components. Preferably, the lateral windows are connected in parallel.

According to another aspect of the invention, there is provided A public transportation vehicle comprising a side wall provided with lateral window openings, and a photovoltaic power generation system as described hereinbefore, wherein the set of one or more lateral windows of the photovoltaic power generation system are framed into one or more of the window openings.

### BRIEF DESCRIPTION OF THE FIGURES

Other advantages and features of the invention will then become more clearly apparent from the following description of a specific embodiment of the invention given as non-restrictive examples only and represented in the accompanying drawings in which:

FIG. 1 is a diagrammatic illustration of a pair of side walls of a vehicle body of a rail vehicle, provided with lateral windows according to an embodiment of the invention;

FIG. 2 is a partially cut isometric view of an upper inside corner of one of the lateral windows of FIG. 1, provided with an inlet plug;

FIG. 3 is a section of the upper corner of the lateral window of FIG. 2;

FIG. 4 is a detailed exploded view of the inlet plug of FIG. 2;

FIG. 5 is an electric power distribution diagram of a rail vehicle provided with the windows of FIG. 1;

FIG. 6 is a partially cut isometric view of a lateral window according to a second embodiment of the invention;

FIG. 7 is a cross-section of the upper corner of the lateral window of FIG. 6;

FIG. 8 is a longitudinal section of the upper corner of the lateral window of FIG. 6.

Corresponding reference numerals refer to the same or corresponding parts in each of the figures.

### DETAILED DESCRIPTION OF PREFERRED EMBODIMENTS

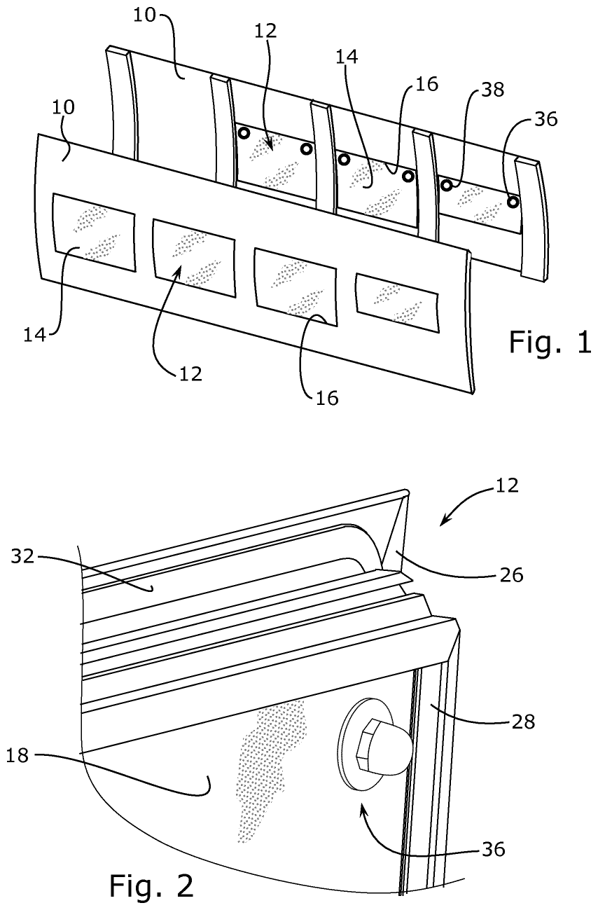

With reference to FIG. 1, the side walls 10 of a public transportation vehicle, and more specifically of a rail vehicle, are provided with lateral windows 12, each comprising a set of transparent panels 14 glazed to a window frame 16, which itself is received in a window opening of the side wall 10.

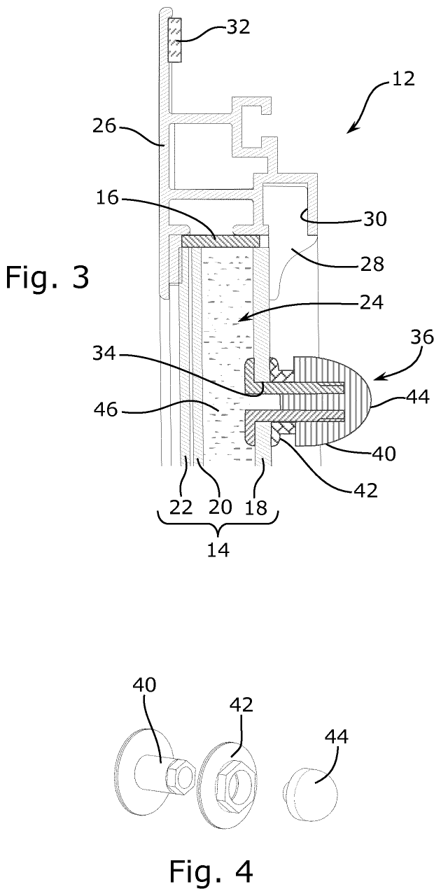

As illustrated in FIGS. 2 and 3, the set of transparent panel 14 of each lateral window 12 includes an inner transparent panel 18, an intermediate transparent panel 20 and an outer transparent panel 22 adhesively bonded to the intermediate transparent panel 18. A resilient spacer frame (not shown) ensures that the inner transparent panel 18 and the intermediate transparent panel 20 are spaced apart so as to define a closed inner space 24 therebetween. Each transparent panel 18, 20, 22 may be made of glass or an appropriate transparent plastic material, e.g. acrylic glass, or may be a multi-layered panel with different materials. Different materials may be used for the inner, outer and/or intermediate transparent panels 18, 20, 22. The outer and intermediate transparent panels 20, 22 may be replaced with a single panel.

The frame 16 of each lateral window 12 is substantially rectangular and comprises four sides, each formed from a main profile 26 and a clamping profile 28 received in a groove 30 of the main profile 26. The main profile 26 provides an interface with the side wall 10 of the vehicle. A sealing gasket 32 is provided between the main profile and the side wall of the vehicle. The clamping profile 28 protrudes from the groove 30 and has a region of overlap with the inner transparent panel 18.

The inner transparent panel 18 has a pair of through holes 34 (only one of which is illustrated in FIG. 3), which constitute an inlet 36 and an outlet 38 between the inner space 24 and the outside. A tubular screw 40 protrudes from each through hole 34. A nut 42 is screwed on a first thread of the tubular screw 40 to fix the tubular screw 40 to the inner transparent panel 18. A threaded cap 44 is engaged on a second thread of the tubular screw 40 to close the protruding open end of the tubular screw 40.

The inlet 36 is used to fill the inner space 24 with a transparent photovoltaic gel 46 while the air in the inner space 24 is expelled through the outlet 38. Once the inner space 24 has been filled with the photovoltaic gel 46, the inlet 36 and outlet 38 are closed and sealed with the closure 44. The inlet 46 and outlet 48 can be of similar construction or can be different from one another (e.g. to include check valves).

The photovoltaic gel is preferably a sol-gel of Si₂Oₓ in a water matrix.

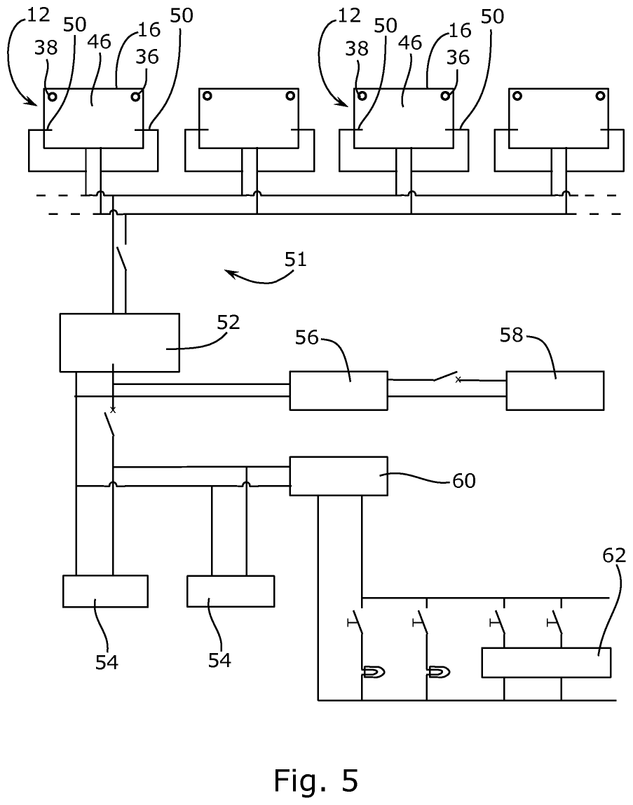

As depicted in FIG. 5, two electrodes 50 are provided on two opposite sides or two opposite corners of the frame 16 and are brought in contact with the transparent photovoltaic gel 46 in the inner space to electrically connect the transparent photovoltaic gel with an electrical circuit 51. The pairs of electrodes 50 of the lateral windows 12 on one side of the vehicle are connected in parallel with a battery charger controller 52, which is also connected to a set of batteries 54, and to a DC/AC inverter 56 to distribute AC power to various AC power consumers 58 in the vehicle. The batteries 54 are connected to a battery discharger controller 60 to distribute DC power to various DC power consumers 62 in the vehicle.

In the operational state, when the vehicle is in or out of service during daylight hours, the lateral windows 12 generate electrical power, which is used either to directly feed the DC/AC inverter 56 or to charge the batteries 54. Peak performances in standard lighting (1000 w/m²) are in the range of 90 to 100 W/m². The voltage obtained between the electrodes vary from 2 to 3.5 V depending on the thickness of the gel layer. Favourable thicknesses (i.e. distance between inner transparent panel and intermediate transparent panel) range from 4 to 8 mm.

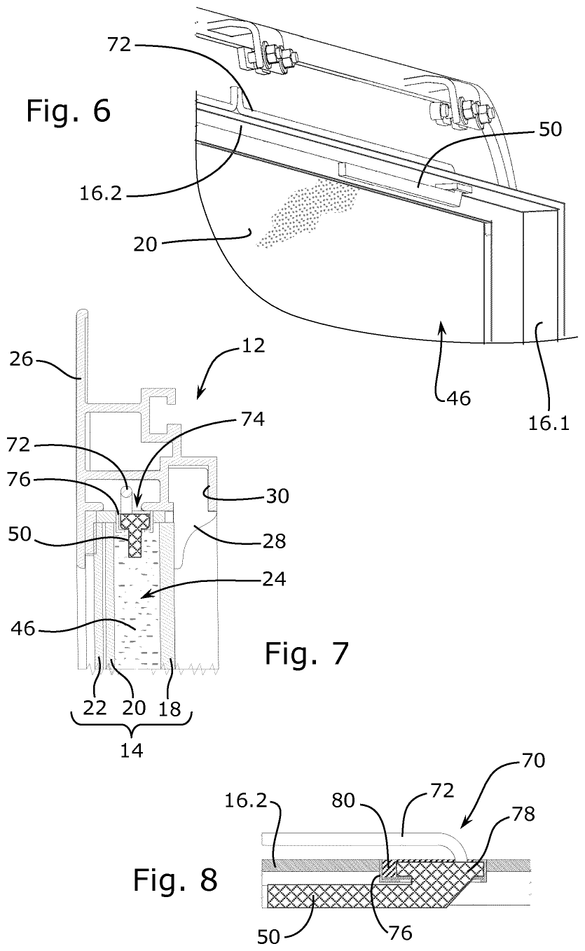

Referring to FIGS. 6 to 8, a lateral window 12 according to a second embodiment comprises a set of transparent panels 14 glazed to a window frame 16. The set of transparent panel 14 includes an inner transparent panel 18, an intermediate transparent 20 panel and an outer transparent panel 22 adhesively bonded to the intermediate transparent panel 18. A resilient spacer frame (not shown) ensures that the inner transparent panel 18 and the intermediate transparent panel 20 are spaced apart so as to define a closed inner space 24 therebetween. A number of electrodes 50 are distributed on the side members 16.1 upper member 16.2 and lower member of the window frame. Each electrode 50 consists of a metallic rod, which runs parallel to the associated frame member and is immersed in a transparent photovoltaic gel 46 that fills in the inner space 24. Some of the electrodes 50 may be connected with one another. At least two of the electrodes 50, preferably associated with the upper member 16.2 of the frame 16, are connected to an external circuit similar to the circuit 51 of FIG. 5 through a bushing 70 and an a cable 72. The bushing 70 is illustrated in its final operational state in FIG. 8. FIG. 8 illustrates an opening 74 in the upper frame member 16.2 for accommodating the bushing 70, and an open bushing housing 76 received in the opening. The electrodes 50 comprises a T-shape end portion 78 which forms a key that can slide in the housing from a free position to a locked position illustrated in FIG. 8. Preferably, the whole electrode 50 is shaped such that it can be inserted into the inner space 24 through the bushing housing 76. Once the T-shaped end portion 78 of the electrode is in the locked position, a sealing cap 80 made of silicone or of a non-cured elastomeric material is injected into the free space between the T-shaped end of the electrode allowed to polymerise to close the bushing 70.

The opening of the bushing housing is used to fill the inner space 24 of the lateral window 12 with the transparent photovoltaic gel 46, either before the electrode is put in place, or after the electrode has been inserted in the bushing but before it is locked with the sealing cap 80. As there are at least two such openings, one can be used as inlet to fill the inner space 24 while the other is used as outlet to expel the air from the inner space 24.

While the above examples illustrate preferred embodiments of the present invention it is noted that various other arrangements can also be considered. The electrical circuit 51 can include any subset of lateral windows 12 on one or both sides of the vehicle body or one more than one vehicle body. The shape of the window can vary.

1. A lateral window for a public transportation vehicle, the lateral window comprising:
a first transparent panel;
a second transparent panel spaced apart from the first transparent panel; and
a window frame comprising a main profile for supporting the first transparent panel and the second transparent panel, an inner space being defined between the first and second transparent panels and the window frame;
a transparent photovoltaic gel filling the inner space; and
a filling arrangement for filling the inner space with the photovoltaic gel.

2. The lateral window of claim 1, wherein the photovoltaic gel contains a silicon gel and a semiconductor.

3. The lateral window of claim 1, wherein the photovoltaic gel completely fills the inner space.

4. The lateral window of claim 1, wherein the first and second transparent panels are planar.

5. The lateral window of claim 1, wherein the filling arrangement comprises a filling inlet for introducing the photovoltaic gel into the inner space, a pressure compensation outlet for allowing air to leave the inner space and closure elements for closing the filling inlet and pressure compensation outlet.

6. The lateral window of claim 5, wherein the filling inlet comprises a through hole in the first transparent panel.

7. The lateral window of claim 5, wherein the pressure compensation outlet comprises a through hole in the first transparent panel.

8. The lateral window of claim 5, wherein the filling inlet and pressure compensation outlet are arranged in one or more frame members of the window frame.

9. The lateral window of claim 1, further comprising a pair of electrodes spaced apart from one another for electrically connecting the photovoltaic gel to an outside electrical circuit through the window frame.

10. The lateral window of claim 9, wherein the electrodes are arranged on the window frame.

11. The lateral window of claim 8, further comprising at least two openings in the window frame, wherein the two openings form the filling inlet and pressure outlet and are closed by bushings that connect the electrodes to an outside circuit.

12. A photovoltaic power generation system for a public transportation vehicle, the photovoltaic power generation system comprising a set of one or more lateral windows according to claim 8 and an electrical circuit for connecting the electrodes of the one or more lateral windows to one or more electrical components amongst the following:
a set of one or more batteries;
one or more DC loads; and
one or more AC loads.

13. The photovoltaic power generation system of claim 12, wherein the electrical circuit includes a charger controller between the electrodes and the one or more electrical components.

14. The photovoltaic power generation system of claim 12, wherein the lateral windows are connected in parallel.

15. A public transportation vehicle comprising a side wall provided with lateral window openings, and a photovoltaic power generation system according to claim 12, wherein the set of one or more lateral windows the photovoltaic power generation system are framed into one or more of the window openings.

16. The lateral window of claim 8, further comprising a pair of electrodes spaced apart from one another for electrically connecting the photovoltaic gel to an outside electrical circuit through the window frame.
